(19) United States
(12) Patent Application Publication
(10) Pub. No.: US 2014/0101424 A1
(43) Pub. Date: Apr. 10, 2014

(54) Cooperative Boot Techniques for an Enterprise Computing System

(71) Applicant: CISCO TECHNOLOGY, INC., San Jose, CA (US)

(72) Inventor: Raghu Krishnamurthy, Santa Clara, CA (US)

(73) Assignee: CISCO TECHNOLOGY, INC., San Jose, CA (US)

(21) Appl. No.: 13/645,824

(22) Filed: Oct. 5, 2012

(51) Int. Cl. G06F 9/06; G06F 15/16

(52) U.S. Cl. 713/2

(57) ABSTRACT

Cooperative boot techniques enable sharing of information in an enterprise computing system so as to optimize performance of the system. For example, in an enterprise computing system comprising a management server, one or more server computers, and a storage subsystem, the management server monitors the one or more server computers for a notification that a server computer has started boot operations. The management server determines that a first server computer has started boot operation, and notifies the storage subsystem that a boot-data request is forthcoming from the first server computer. The storage subsystem is notified that the first server computer has started boot operations before the first server computer has completed boot operations so that that the storage subsystem can prepare data likely to be requested in the boot-data request.

### TECHNICAL FIELD

The present disclosure relates to boot operations in an enterprise computing system.

### BACKGROUND

An enterprise computing system comprises groups of components interconnected by a network so as to form an integrated and large scale computing entity. More specifically, an enterprise computing system comprises multiple server computers (servers), commonly referred to as rack or blade servers, which provide any of a variety of functions. The blade servers are generally connected to a management server that provides management, virtualization, and a switching fabric. One example of an enterprise computing system is Cisco's® Unified Computing System (UCS).

### BRIEF DESCRIPTION OF THE DRAWINGS

FIG. 1 is a block diagram of an enterprise computing system configured to execute cooperative boot techniques.

FIG. 2 is a flowchart of a method for cooperative boot techniques in an enterprise computing environment.

FIG. 3 is a flow diagram illustrating notifications used during the method of FIG. 2.

FIG. 4 is a block diagram illustrating a control path of an enterprise computing system configured to execute cooperative boot techniques.

FIG. 5 is a high level flowchart of a method for cooperative boot techniques in an enterprise computing system.

### DESCRIPTION OF EXAMPLE EMBODIMENTS

### Overview

Cooperative boot techniques enable sharing of information in an enterprise computing system so as to optimize performance of the system. For example, in an enterprise computing system comprising a management server, one or more server computers, and a storage subsystem, the management server monitors the one or more server computers for a notification that a server computer has started boot operations. The management server determines that a first server computer has started boot operations, and notifies the storage subsystem that a boot-data request is forthcoming from the first server computer. The storage subsystem is notified that the first server computer has started boot operations before the first server computer has completed boot operations so that that the storage subsystem can prepare data in anticipation of (i.e., prepare data likely to be requested in) the boot-data request.

### Example Embodiments

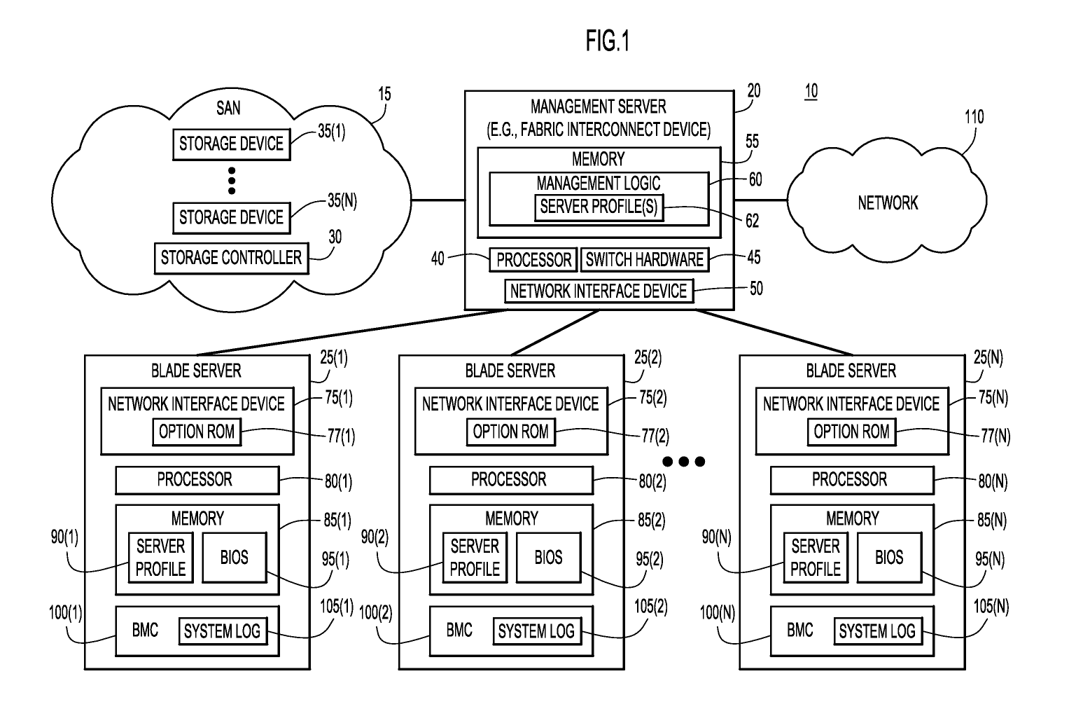

FIG. 1 is a block diagram of an example enterprise computing system 10 configured to execute cooperative boot techniques. Enterprise computing system 10 comprises a storage subsystem, referred to herein as a storage area network (SAN) 15, a management server 20, and a plurality of server computers (servers) 25(1)-25(N).

SAN 15 comprises a storage controller 30 and a plurality of storage devices 35(1)-35(N). Storage controller 30 may be, for example, a hardware component (e.g., application specific integrated circuit (ASIC), a software component on a dedicated server, a software component on a storage device, etc. Management server 20 comprises a processor 40, switch hardware 45, a network interface device 50, and a memory 55 that includes management logic 60. Management logic 60 includes a plurality of service profiles 62 for distribution to the servers 25(1)-25(N).

Each server 25(1)-25(N) comprises a network device 75(1)-75(N), respectively, a processor 80(1)-80(N), respectively, and a memory 85(1)-85(N), respectively. Each memory 85(1)-85(N) stores data describing a service profile 90(1)-90(N), respectively, and instructions for a Basic Input/Output Operating System (BIOS) 95(1)-95(N), respectively. Each server 25(1)-25(N) also comprises a baseboard management controller (BMC) 100(1)-100(N), respectively. Each baseboard management controller 100(1)-100(N) includes a system log 105(1)-105(N), respectively. Network interface devices 75(1)-75(N) each comprise an option read only memory (ROM) 77(1)-77(N), respectively.

The plurality of servers 25(1)-25(N) serve as a pool of computing resources and the storage devices 35(1)-35(N) are used to store data. Requests to use the computing resources of the servers 25(1)-25(N) are received via a network 110 (e.g., local area network, wide area network, etc.). In one example, the management server 20 is a fabric interconnect device (e.g., a data center switch) having multilayer and multiprotocol capabilities that can transport data over Ethernet, including Layer 2 and Layer 3 traffic, and that can store traffic, all on one common data center-class platform. The servers 25(1)-25(N) are sometimes referred to herein as rack or blade servers because they may be embodied in a “rack” or “blade” configuration to mount within a chassis unit that has slots for multiple servers.

Each blade server 25(1)-25(N) is provisioned with a service profile 90(1)-90(N), respectively, by management logic 60. A service profile comprises data that defines hardware, software, connectivity and operational attributes for the respective blade server. In other words, the service profile is a self-contained definition of the server's configuration and identity. In certain examples, the service profiles 90(1)-90(N) are stored in option ROMs 77(1)-77(N), respectively. When, as described below, the option ROMs 77(1)-77(N) are initially loaded, the service profiles 90(1)-90(N) may be added to memories 85(1)-85(N), respectively.

The management server 20 and, more specifically, management logic 60, controls which service profiles are installed and activated (and de-activated) on the plurality of servers 25(1)-25(N). In the example of FIG. 1, the management server 20 operates as a portal for all control/command and data traffic to/from the servers 25(1)-25(N). More specifically, traffic is received at network interface device 50 and flows through switch hardware 45. The flow of the traffic is controlled through execution of management logic 60 by processor 40. However, this is only an example and in another form the management server 20 may be the point of control for the servers 25(1)-25(N), but all traffic to and from the servers passes through a separate switching entity.

As noted, the servers 25(1)-25(N) each comprise a memory 85(1)-85(N), respectively. Management server 20 also comprises a memory 55. Memories 85(1)-85(N) and 55 may comprise ROM, random access memory (RAM), magnetic disk storage media devices, optical storage media devices, flash memory devices, electrical, optical, or other physical/tangible memory storage devices. The processors 80(1)-80(N) and 40 are, for example, microprocessors or microcontrollers that execute instructions for the various software modules stores in the associated memory. For example, processors 80(1)-80(N) may execute instructions for the service profiles 90(1)-90(N), respectively, and BIOSs 95(1)-95(N), respectively. Thus, in general, the memories 85(1)-85(N) and 55 may comprise one or more tangible (non-transitory) computer readable storage media (e.g., a memory device) encoded with software comprising computer executable instructions and when the software is executed (by the respective processor) it is operable to perform the operations described herein in connection with service profiles 90(1)-90(N), respectively, BIOSs 95(1)-95(N), respectively, and management logic 60.

In certain circumstances, servers 25(1)-25(N) may need to perform a boot operation. In computing, a boot operation (also known as booting or booting up) is the initial set of operations that a system performs when electrical power is supplied to the system. The process begins when a computer that has been turned off is initially energized/re-energized, and ends when the system is ready to perform its normal operations. For ease of illustration, boot operation of the enterprise computing system 10 will be described with reference to server 25(1) only. It is to be appreciated that the other servers 25(2)-25(N) may execute similar boot operations.

As noted, server 25(1) includes a BIOS 95(1). BIOS 95(1) is software in the form of a small set of programs or routines that allow the hardware of the server 25(1) to interact with the operating system (not shown) by a set of standard calls. The BIOS 95(1), when executed by processor 80(1), enables several tasks to be performed. In particular, the BIOS 95(1) causes the processor 80(1) to read the contents of a specific memory address that is preprogrammed into the processor 80(1). In the case of x86 based processors, this address is FFFF:0000h (i.e., the last 16 bytes of memory at the end of the first megabyte of memory). The code that the processor reads is actually a jump command (JMP) telling the processor where to go in memory to read the BIOS Read Only Memory (ROM). Next, the BIOS 95(1) will cause the processor 80(1) to perform a Power On Self Test (POST). The POST is a series of individual functions or routines that perform various initializations and tests of the hardware of blade server 25(1). For example, the BIOS 95(1) may start with a series of tests of processor 80(1) and/or any coprocessors, timer(s), adapters, etc. The type and order in which these tests are performed may vary depending on the configuration of the server 25(1). POSTs are generally known in the art and are not described further herein.

In a conventional enterprise computing system, once the POST is complete with no errors, the BIOS 95(1) will load an option ROM 77(1) and initiate connectivity with the management server 20. As such, boot information is stored on the network interface device 75(1) as part of service profile deployment and this boot information is loaded for subsequent use.

The BIOS 95(1) will then hand over operation to the operating system which will transmit read requests, also referred to herein as boot-data requests, to SAN 15. The operating system will typically transmit multiple boot-data requests to load several pieces of data used to commence operation. In other words, these conventional arrangements wait until the POST is complete before transmitting the boot-data requests to SAN 15.

In general, the initial boot procedures (including POST) may take approximately 60 to 80 seconds to complete. As such, there is a significant delay before the operating system transmits the boot-data requests to SAN 15. Another problem faced during boot is the delayed response of the SAN 15 to the boot-data requests. The delays are attributable to, for example, storage layer congestion or network bandwidth congestion (in case of a boot storm), storage layer intelligence using Copy-on-Write, thin provisioning using data constructed dynamically in response to a read request, storage layer arrangement (i.e., the storage appliances spread across different physical storages technologies (FLASH storage, Serial AT attachment (SATA), etc.)), and/or because the storage layer caches data, but the caching does not begin until after receipt of the boot-data request. These problems are exacerbated in enterprise computing systems when a large number of systems (chassis/servers) are rebooted substantially simultaneously.

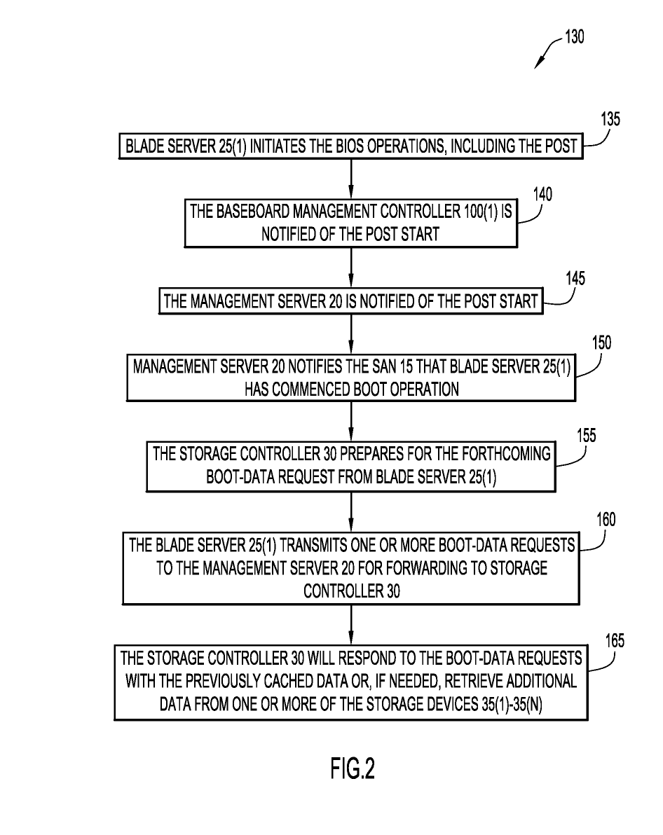

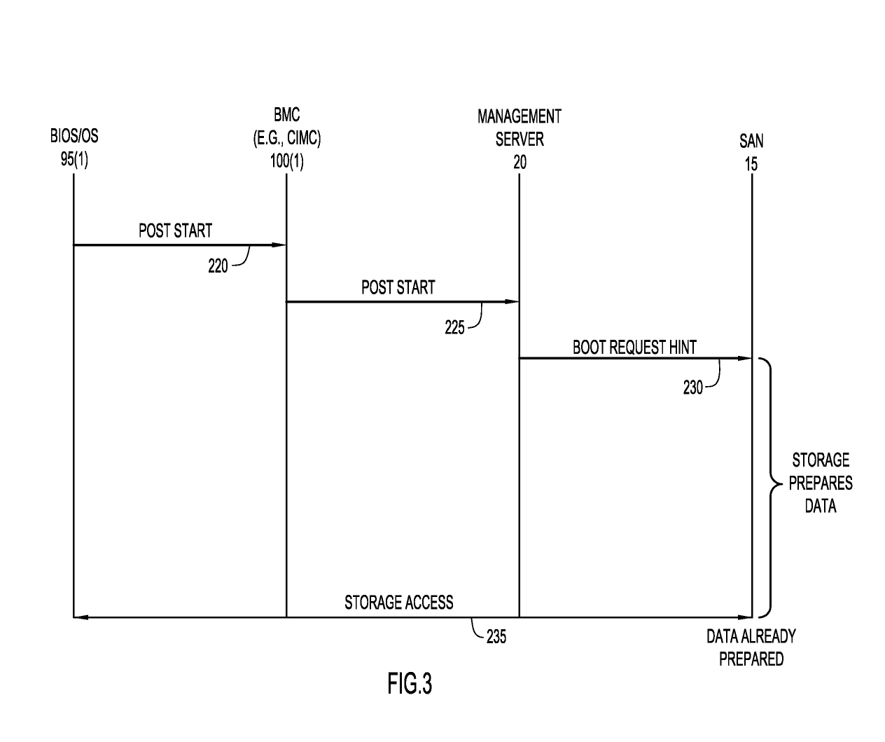

Presented herein are techniques in which a booting server in an enterprise computing environment cooperatively shares information about the boot process with other components of the enterprise computing environment (e.g., management, storage, network, etc.) to optimize storage access and decrease the time to bring the booting server online. FIG. 2 is a flowchart illustrating an example method 130 executed in accordance with such cooperative boot techniques. FIG. 3 is a flow diagram of notifications transmitted during method 130 of FIG. 2.

For ease of illustration, the examples of FIGS. 2 and 3 will be described with reference to the enterprise computing environment 10 of FIG. 1 and, more particularly, with reference to boot operation of server 25(1).

Method 130 begins at 135 where server 25(1) initiates the BIOS operations, including the POST. At 140, the baseboard management controller 100(1) is notified of the POST start. This notification is represented by arrow 220 in FIG. 3. In one example, the baseboard management controller 100(1) maintains a system log 105(1) and, upon commencement of the POST, an event is added to the system log 105(1) indicating that the POST has commenced.

At 145, the management server 20 is notified of the POST start. This notification is represented by arrow 225 in FIG. 3. In one example, the management software (shown as management logic 60 in FIG. 1) is configured to monitor the baseboard management controller 100(1) and to detect the addition of the event to the system log 105(1) indicating that the POST has started.

At 150, the management server 20 notifies the SAN 15 that blade server 25(1) has commenced boot operation, and that a boot-data request will occur in the near future (e.g., within 60-120 seconds). This notification is represented by arrow 230 in FIG. 3 and occurs before the POST is completed at the server 25(1). In one example, the management software 60 notifies the storage controller 30 of the upcoming boot-data request.

At 155, in response to this notification, the storage controller 30 prepares for the upcoming boot-data request from server 25(1). This preparation may include, for example, determining what data is likely to be requested by server 25(1), caching the data likely to be requested, and otherwise preparing the data so that it can be easily provided to the server 25(1) upon receipt of the boot-data request. These cooperative boot techniques allow the SAN 15 to prepare for the boot-data requests while the BIOS 95(1) is still performing POST, thereby providing the storage subsystem with a significant amount of time to prepare. The preparation of the data at the same time as the POST reduces the latency period needed after receipt of the boot-data request (i.e., some or all of the data needed to fulfill the boot-data request has already been cached, thereby reducing the time to provide data back to blade server 25(1)).

At 160, the POST is completed, the BIOS Option ROM is loaded, and the server 25(1) will transmit a boot-data request to the management server 20 for forwarding to storage controller 30. As a result of the boot request notification 230, the SAN 15 is ready to handle the boot-data request with a faster response time (relative to an arrangement where the boot-data request operates as the trigger to begin data preparation). More specifically, at 165, the storage controller 30 will respond to the boot-data request with the previously cached data or, if needed, retrieve additional data from one or more of the storage devices 35(1)-35(N). The storage access (boot-data request and subsequent response) is represented in FIG. 3 by bi-directional arrow 235.

Method 130 of FIG. 2 illustrates only one example of the cooperative boot techniques and it is to be appreciated that the cooperative information sharing may be extended to other components and be used for different purposes. For example, in one variation the baseboard management controller 100(1) may be notified of the end of the POST or the end of the boot operation. In one such example, upon completion of the POST or boot operation, an event is added to the system log 105(1) indicating that the POST or boot operation has been completed. Subsequently, the management server 20 may be notified of the end of the POST or boot operation. In one example, the management software 60 is configured to monitor the baseboard management controller 100(1) to detect the addition of the event to the system log 105(1) indicating that the POST or boot operation has completed. The management server 20 may then notify the SAN 15 that blade server 25(1) has completed the POST or boot operation.

Notifying the storage controller 30 that the POST or boot operation has been completed enables the storage controller 30 to determine what was read between the starting and ending events (bounded time period) and dynamically keep track of what storage access is used by server 25(1). In other words, the storage controller 30 is configured to dynamically and intelligently learn on each boot what data is likely to be requested by server 25(1). By learning what data will be requested by server 25(1), the storage controller 30 can minimize the amount of data that needs to be cached.

Server 25(1) comprises a network interface device 75(1) that may be, in one example, a virtual interface card (VIC) configured to perform one or more operations on behalf of the BIOS or operating system of server 25(1). In one example, the network interface device 75(1) is configured to extend the cooperative boot techniques so that the data needed by server 25(1) is more readily accessible to the server. More specifically, after storage controller 30 prepares the data that is likely to be needed to satisfy the forthcoming boot-data request, the network interface device 75(1) may be configured to transmit a “proxy” boot-data request prior to completion of the POST. The storage controller 30 may respond to this proxy boot-data request so that the data likely to be used by server 25(1) is cached at the network interface device 75(1), rather than at SAN 15. In this way, when the POST is completed, there is no need for server 25(1) to transmit the boot-data request and wait for a response from SAN 15. Rather, the data may be immediately retrieved from the network interface device 75(1). In summary, the network interface device 75(1) may be configured to function as a proxy to obtain the boot data before it is needed by the server 25(1).

As shown in FIG. 1, the enterprise computing system 10 may comprise a plurality of servers 25(1)-25(N). A number of these servers 25(1)-25(N) may boot at substantially the same time such that a significant amount of bandwidth or other resources may be needed to timely support all of the boot-data requests and responses. In one example, if the management software 60 detects that multiple servers 25(1)-25(N) have commenced boot (i.e., by receiving notifications of their POST starts), the management software may temporarily increase the network bandwidth available to the servers 25(1)-25(N) so as to be able to accommodate the boot-data requests and subsequent responses. In one example, the management software 60 informs the network path elements (e.g., SAN switches, LAN switches, etc.) that multiple boot-data requests are forthcoming so that the network path elements can allocate more bandwidth on the fly. The management software 60 may decrease the network bandwidth available to the servers 25(1)-25(N) after the boot-data has been received by the servers.

In another example, if the management software 60 detects that multiple servers 25(1)-25(N) have commenced boot, the management software 60 may stagger the boot processes so that certain servers are booted before other boot servers. More specifically, certain servers may perform more important or priority operations, while other servers perform less important operations. If all of the servers boot at the same time, the boot process may be overly slow or result in less important servers coming online before priority servers. As such, the management software can stagger or control the boot (i.e., stop boot of some less important servers) so that the priority blade servers are the first servers brought online. In other words, the management software is configured to delay the boot operations of certain servers so that other servers are brought online faster.

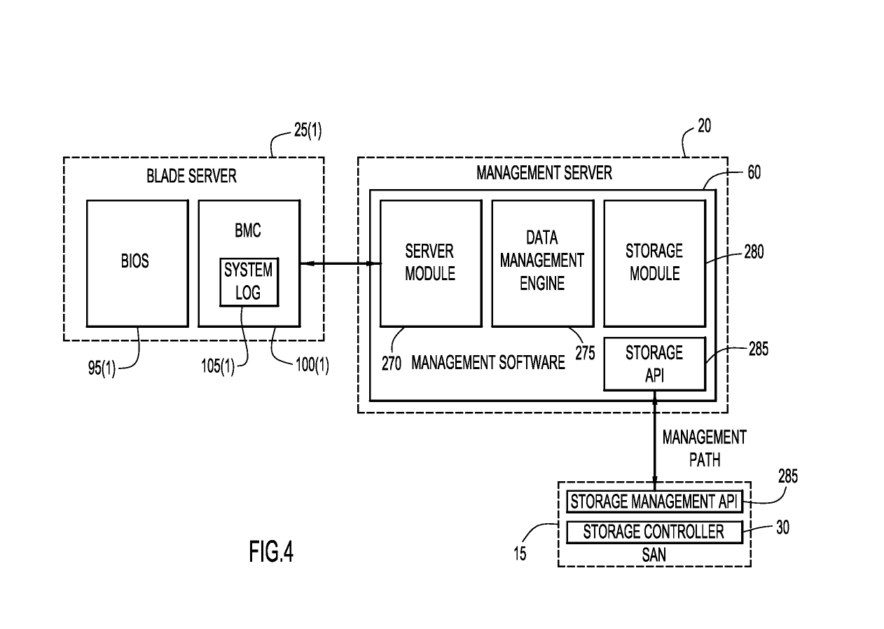

FIG. 4 is a block diagram illustrating components of enterprise computing environment 10 that are used to execute the cooperative boot techniques. The BIOS 95(1) is executed such that an event is created in system log 105(1) indicating that blade server 25(1) has commenced boot operation. Management software 60 includes server module 270, data management engine 275, and storage module 280. The server module 270 is an application process that monitors the BMC 100(1) (i.e., system log 105(1)) for a POST start event. Data management engine 275 holds the information of the server 25(1) and performs the activity for pre-deployment. Storage module 280 is an application process that interacts with the storage controller 30 of SAN 15 via storage application program interface (API) 285.

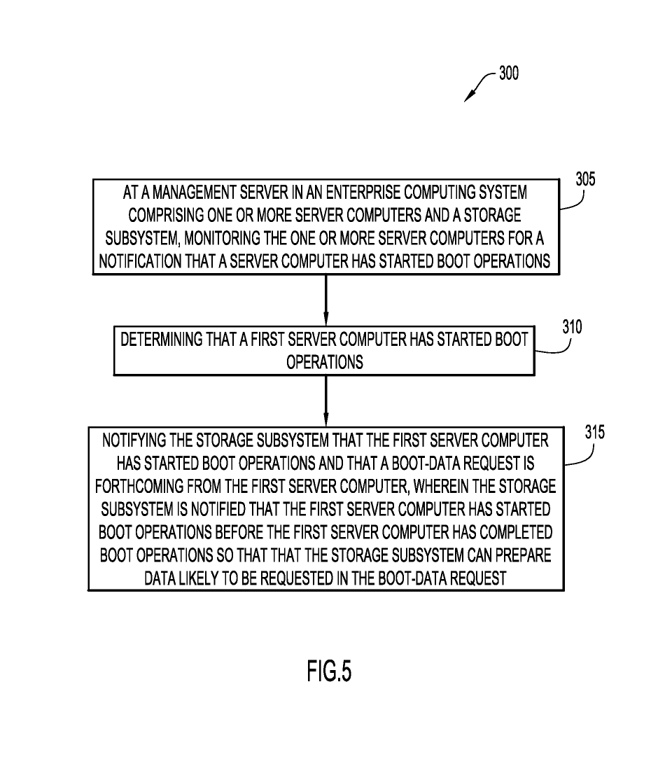

FIG. 5 is a flowchart of a high-level method 300 in accordance with the cooperative boot techniques executed at a management server in an enterprise computing system comprising one or more server computers and a storage subsystem. Method 300 begins at 305 where the management server monitors the one or more server computers for a notification that a server computer has started boot operations. At 310, the management server determines that a first server computer has started boot operations. At 315, the management server notifies the storage subsystem that the first server computer has started boot operations and that a boot-data request is forthcoming from the first server computer so that that the storage subsystem can prepare data likely to be requested in the boot-data request. The storage subsystem is notified that the first server computer has started boot operations before the first server computer has completed boot operations. The storage subsystem may be notified that the first server computer has started boot operations before the first server computer has completed a POST.

In one example, the management server receives a boot-data request from the first server computer and forwards the boot-data request to the storage subsystem. The management server may then receive a response from the storage subsystem that includes boot data for the first server computer and forwards the response from the storage subsystem to the first server computer.

In another example, the management server may receive a proxy boot-data request from a network interface device of the first server computer before the first server has completed the boot operations. The management server is configured to forward the proxy boot-data request to the storage subsystem and receive a response from the storage subsystem that includes boot data requested in the proxy boot-data request. The boot data in the response from the storage subsystem may be forwarded to the first server computer for caching at the network interface device of the first server.

In a further example, the management server is configured to monitor the first server computer for a notification that the first server computer has completed boot operations. The management server determines that the first server computer has completed boot operations, and then notifies the storage subsystem that the first server computer has completed boot operations. In another example, the enterprise computing system comprises a plurality of servers and the management server is configured to determine that two or more of the plurality of server computers have each started boot operations. The management server is configured to notify the storage subsystem that the two or more server computers have started boot operations before the two or more server computers have completed boot operations, and to temporarily increase network bandwidth available to the two or more server computers so as to be able to accommodate boot-data requests forthcoming from the two or more server computers. In another example, the enterprise computing system comprises a plurality of servers and the management server is configured to determine that two or more of the plurality of server computers have each started boot operations. The management server is configured to notify the storage subsystem that the two or more server computers have started boot operations before the two or more server computers have completed boot operations, and to temporarily delay the boot operations of one or more of the two or more server computers.

The cooperative boot techniques described herein provide an operating system-independent and “out of band” mechanism for improving boot times by cooperatively sharing information about when a POST starts. This process allows other components in an enterprise computing system to have a period amount of time (e.g., 20-100 seconds) to proactively optimize their access, rather than having to react to a boot-data request.

The above description is intended by way of example only.

What is claimed is:

1. A method comprising:
at a management server in an enterprise computing system comprising one or more server computers and a storage subsystem, monitoring the one or more server computers for a notification that a server computer has started boot operations;
determining that a first server computer has started boot operations; and
notifying the storage subsystem that the first server computer has started boot operations and that a boot-data request is forthcoming from the first server computer, wherein the storage subsystem is notified that the first server computer has started boot operations before the first server computer has completed boot operations so that that the storage subsystem can prepare data likely to be requested in the boot-data request.

2. The method of claim 1, comprising:
receiving a boot-data request from the first server computer;
forwarding the boot-data request to the storage subsystem;
receiving a response from the storage subsystem that includes boot data for the first server computer; and
forwarding the boot data to the first server computer.

3. The method of claim 1, comprising:
receiving a proxy boot-data request from a network interface device of the first server computer before the first server computer has completed the boot operations;
forwarding the proxy boot-data request to the storage subsystem;
receiving a response from the storage subsystem that includes boot data requested in the proxy boot-data request; and
forwarding the boot data to the first server computer for caching at the network interface device of the first server computer.

4. The method of claim 1, further comprising:
monitoring the first server computer for a notification that the first server computer has completed boot operations;
determining that the first server computer has completed boot operations; and
notifying the storage subsystem that the first server computer has completed boot operations.

5. The method of claim 4, wherein monitoring the first server computer for a notification that the first server computer has completed boot operations comprises:
monitoring a system log of a baseboard management controller of the first server computer for the occurrence of an event indicating that the first server computer has completed a Power On Self Test.

6. The method of claim 1, wherein the enterprise computing system comprises a plurality of server computers and further comprising:
determining that two or more of the plurality of server computers have each started boot operations;
notifying the storage subsystem that the two or more server computers have started boot operations before the two or more server computers have completed boot operations; and
temporarily increasing network bandwidth available to the two or more server computers so as to be able to accommodate boot-data requests forthcoming from the two or more server computers.

7. The method of claim 1, wherein the enterprise computing system comprises a plurality of server computers and further comprising:
determining that two or more of the plurality of server computers have each started boot operations;
temporarily delaying the boot operations of at least one of the two or more server computers; and
notifying the storage subsystem of the start of the boot operations of any server computers having boot operations that have not been delayed.

8. The method of claim 1, wherein monitoring the first server computer for a notification that the first server computer has started boot operations comprises:
monitoring a system log of a baseboard management controller of the first server computer for the occurrence of an event indicating that the first server computer has started a Power On Self Test.

9. A system comprising:
a plurality of server computers;
a storage subsystem; and
a management server configured to:
monitor the plurality of server computers for a notification that a server computer has started boot operations,
determine that a first server computer has started boot operations, and
notify the storage subsystem that the first server computer has started boot operations and that a boot-data request is forthcoming from the first server computer,
wherein the storage subsystem is notified that the first server computer has started boot operations before the first server computer has completed boot operations so that that the storage subsystem can prepare data likely to be requested in the boot-data request.

10. The system of claim 9, wherein in response to the notification that the first server computer has started boot operations, the storage subsystem is configured to determine what data is likely to be requested by the first server computer and to cache the data likely to be requested by the first server computer.

11. The system of claim 10, wherein the management server is configured to receive a boot-data request from the first server computer and forward the boot-data request to the storage subsystem, and wherein the storage subsystem is configured to respond to the boot-data request with the data that was cached in response to the notification that the first server computer has started boot operations.

12. An apparatus comprising:
a network interface device configured to enable communications over a network with one or more server computers and a storage subsystem;
a memory; and
a processor coupled to the network interface and memory, and configured to:
monitor the one or more server computers for a notification that a server computer has started boot operations;
determine that a first server computer has started boot operations, and
notify the storage subsystem that the first server computer has started boot operations and that a boot-data request is forthcoming from the first server computer,
wherein the storage subsystem is notified that the first server computer has started boot operations before the first server computer has completed boot operations so that that the storage subsystem can prepare data likely to be requested in the boot-data request.

13. The apparatus of claim 12, wherein the processor is configured to:
receive a boot-data request from the first server computer;
forward the boot-data request to the storage subsystem;
receive a response from the storage subsystem that includes boot data for the first server computer; and
forward the boot data to the first server computer.

14. The apparatus of claim 12, wherein the processor is configured to:
receive a proxy boot-data request from a network interface device of the first server computer before the first server computer has completed the boot operations;
forward the proxy boot-data request to the storage subsystem;
receive a response from the storage subsystem that includes boot data requested in the proxy boot-data request; and
forward the boot data to the first server computer for caching at the network interface device of the first server computer.

15. The apparatus of claim 12, wherein the processor is configured to:
monitor the first server computer for a notification that the first server computer has completed boot operations;
determine that a first server computer has completed boot operations; and
notify the storage subsystem that the first server computer has completed boot operations.

16. The apparatus of claim 15, wherein to monitor the first server computer for a notification that the first server computer has completed boot operations, the processor is configured to:
monitor a system log of a baseboard management controller of the first server computer for the occurrence of an event indicating that the first server computer has completed a Power On Self Test.

17. The apparatus of claim 12, wherein the one or more server computers comprise a plurality of server computers and wherein the processor is configured to:
determine that two or more of the plurality of server computers have each started boot operations;
notify the storage subsystem that the two or more server computers have started boot operations before the two or more server computers have completed boot operations; and
temporarily increase network bandwidth available to the two or more server computers so as to be able to accommodate boot-data requests forthcoming from the two or more server computers.

18. The apparatus of claim 12, wherein the one or more server computers comprise a plurality of server computers and wherein the processor is configured to:
determine that two or more of the plurality of server computers have each started boot operations;
temporarily delay the boot operations of at least one of the two or more server computers; and
notify the storage subsystem of the start of the boot operations of any servers that have boot operations that have not been delayed.

19. The apparatus of claim 12, wherein to monitor the first server computer for a notification that the first server computer has started boot operations the processor is configured to:
monitor a system log of a baseboard management controller of the first server computer for the occurrence of an event indicating that the first server computer has started a Power On Self Test.

20. One or more computer readable storage media encoded with software comprising computer executable instructions and when the software is executed operable to:
at a management server in an enterprise computing system comprising one or more server computers and a storage subsystem, monitor the one or more server computers for a notification that a server computer has started boot operations;
determine that a first server computer has started boot operations; and
notify the storage subsystem that the first server computer has started boot operations and that a boot-data request is forthcoming from the first server computer, wherein the storage subsystem is notified that the first server computer has started boot operations before the first server computer has completed boot operations so that that the storage subsystem can prepare data likely to be requested in the boot-data request.

21. The computer readable storage media of claim 20, further comprising instructions operable to:
receive a boot-data request from the first server computer;
forward the boot-data request to the storage subsystem;
receive a response from the storage subsystem that includes boot data for the first server computer; and
forward the boot data to the first server computer.

22. The computer readable storage media of claim 20, further comprising instructions operable to:
receive a proxy boot-data request from a network interface device of the first server computer before the first server computer has completed the boot operations;
forward the proxy boot-data request to the storage subsystem;
receive a response from the storage subsystem that includes boot data requested in the proxy boot-data request; and
forward the boot data to the first server computer for caching at the network interface device of the first server computer.

23. The computer readable storage media of claim 20, further comprising instructions operable to:
monitor the first server computer for a notification that the first server computer has completed boot operations;
determine that a first server computer has completed boot operations; and
notify the storage subsystem that the first server computer has completed boot operations.

24. The computer readable storage media of claim 23, wherein the instructions operable to monitor the first server computer for a notification that the first server computer has completed boot operations comprise instructions operable to:
monitor a system log of a baseboard management controller of the first server computer for the occurrence of an event indicating that the first server computer has completed a Power On Self Test.

25. The computer readable storage media of claim 20, wherein the one or more server computers comprise a plurality of server computers and further comprising instructions operable to:
determine that two or more of the plurality of server computers have each started boot operations;
notify the storage subsystem that the two or more server computers have started boot operations before the two or more server computers have completed boot operations; and
temporarily increase network bandwidth available to the two or more server computers so as to be able to accommodate boot-data requests forthcoming from the two or more server computers.

26. The computer readable storage media of claim 20, wherein the one or more server computers comprise a plurality of server computers and further comprising instructions operable to:
determine that two or more of the plurality of server computers have each started boot operations;
temporarily delay the boot operations of at least one of the two or more server computers; and
notify the storage subsystem of the start of the boot operations of any servers that have boot operations that have not been delayed.

27. The computer readable storage media of claim 20, wherein the instructions operable to monitor the first server computer for a notification that the first server computer has started boot operations comprise instructions operable to:
monitor a system log of a baseboard management controller of the first server computer for the occurrence of an event indicating that the first server computer has started a Power On Self Test.
